(19) United States
(12) Patent Application Publication
(10) Pub. No.: US 2013/0045152 A1
(43) Pub. Date: Feb. 21, 2013

(54) Elemental Boron by Reduction of Boron Halides by metals and their borides

(71) Applicant: Ramaswami Neelameggham, South Jordan, UT (US)

(72) Inventor: Ramaswami Neelameggham, South Jordan, UT (US)

(73) Assignee: IND LLC, South Jordan, UT (US)

(21) Appl. No.: 13/209,610

(22) Filed: Aug. 15, 2011

(51) Int. Cl. C01B 35/02; C25B 1/00

(52) U.S. Cl. 423/298; 205/615

(57) ABSTRACT

The quest for making pure boron has been continuing for over 200 years. Most common method has been by hydrogen reduction of boron halides on a hot filament, and this has not been an economical approach. Other techniques using magnesiothermic reduction or electrolysis of oxide compounds of boron produced impure boron. Present invention describes techniques of making pure boron in the amorphous as well as crystalline form—applying thermochemical principles in an efficient manner. The present invention shows that boron halides can be reduced by alkali metal, alkaline earth metal, aluminum or silicon, as well as by alkaline earth borides, aluminum borides, silicon borides into pure elemental boron.

### BACKGROUND OF THE INVENTION

Production of elemental boron in a high purity form has been a difficult and not an economical process for over 200 years. The present invention sets out to see the causes and come up with logical economic methods.

### BRIEF SUMMARY OF THE INVENTION

A comprehensive thermochemical study was made to delineate methods of making high purity elemental boron. The study revealed that the conditions applied to making the elemental boron thus far have been inadequate in overcoming the oxide and stable metal borides inclusions with the elemental boron. The present invention found that boron trihalides can be reduced by metals as well as metal borides in a controlled fashion giving high purity boron, hitherto thought not feasible.

### PRIOR ART

The initial discovery of elemental boron by Humphrey Davy and by Gay Lussac in 1808 was later proven by several others to be an impure material contaminated with oxides, and borides which were quite inseparable from the boron material. In 1892, Moisson came up with a magnesium reduction method of boron oxides which produced about 90% pure boron. In the early twentieth century, Weintraub patented [U.S. Pat. Nos. 1,019,165; 1,074,672 and 1,306, 568] methods wherein boron trichloride vapors were reduced on hot filaments by hydrogen gas giving 99.0% plus pure elemental boron. Even though this produced purer boron, this continues to be a costly method even to date, as the reaction temperatures are very high and the elemental boron tended to react with the filament material. In U.S. Pat. No. 1,774,410 Van Arkel describes a method of self dissociation of boron bromide on a surface which is chemically inert to boron bromide at temperature sufficiently elevated to cause the disassociation of boron bromide solely by heat.

During 1940 through mid 1960s several other patents described preparation of elemental boron from boron containing oxides. U.S. Pat. No. 2,465,989 by Sowa disclosed that amorphous boron can be made from a fusion of a metallic fluoborate reacting with alkali or alkaline earth metals. He obtained boron of 70 to 84% purity using sodium fluoborate or potassium fluoborate reduced by metallic sodium. In 1951, H. S. Cooper, described a method where a molten mixture of potassium chloride [4000 g] and potassium fluoborate [1500 g] was used as an electrolyte to dissolve boron oxide [500 g] which was electrolyzed onto a molybdenum cathode [U.S. Pat. No. 2,572,249].

Richard B. Ellis made boron by electrolysis of a fused mixture of boron and phosphate compounds, indicating that his invention [U.S. Pat. No. 2810683] was less cumbersome than hydrogen reduction of boron trichloride. However, the purity of boron was low.

U.S. Pat. No. 2, 832, 730 by N. N. Perry, et al, describes the electrolysis of 60% KCl, 25% KF and 15% B₂O₃. N. F. Murphy, et al, utilized the electrolysis of alkali metal oxides and boron compounds [U.S. Pat. No., 2,848,396] to make boron. D. R. Stern and Q. H. Mckenna described the electrolysis [up to 1000° C.] using alkali metal chloride, and alkali metal fluoborate using a boron carbide anode and a cathode. D. R. Stern also patented an electrolytic method which made boron of purity to 91% in melts of B₂O₃ with alkaline oxides or fluoborates [U.S. Pat. No. 3,030,284]. Recently, P. Taylor applied for a patent [U.S. Patent Application 2010/0294670 A1] wherein, a less than 90% pure boron was made by electrolyzing B₂O₃ in an electrolyte of MgF₂—NaF—LiF. In 2006, H. Yldiran and S. D. Guler disclosed a novel approach of electrolyzing sodium tetraborate at 1000° C. [WO 2006/135350].

Prior art also showed the following metallothermic approaches. In 1958, J. M. Finn Jr, described a method where metallic zinc is used as the reductant to react with boron halides [U.S. Pat. No. 2,850,494]. This method did not get pursued for economic production of elemental boron. In U.S. Pat. No. 2,897,056, N. P. Nies and E. W. Fajans, describes a magnesiothermic method of making boron from B₂O₃. The purity obtained was about 92%; this was further processed by reacting the resultant impure boron in a melt of potassium fluoborate and potassium chloride [U.S. Pat. No., 2,893,842].

Almadari, et al., describe a mechanochemical reaction of boron oxide or borate compounds with metal granules such as magnesium, aluminum or calcium in a high speed ball mill in Canadian patent [CA 2365641]. The examples shown in this give a measured purity of about 85% for the resultant acid washed boron powder.

### PRESENT INVENTION

The present invention discloses methods of making pure boron by metallothermic reaction of boron halide vapors using alkali metals, alkaline earth metals or aluminum or silicon as well as their borides. None of the prior art disclosed such methods. They either disclosed metallothermic reduction of boron oxide solids, or boron oxide or its compounds contained in melts or fusions by metal or by electrolysis. This invariably introduced oxygen impurities in the boron product, which also continued to be held together with other solid oxide products such as magnesium oxide [if magnesiothermic]. The product elemental boron in most cases reacted with the reductant forming stable metal borides, which prevented the formation of high purity boron. Thus, the prior art for making boron from boron halides utilized mostly hydrogen as the reducing agent [Weintraub patents] or zinc as the reducing agent [Finn patent]. Finn's patent noted that the boron product was substantially pure and was scarped from the tube; while the product zinc chloride vapor was condensed separately as was the unreacted BCl₃ and zinc vapors. It is not known whether this process was ever commercially practised or not. Finn's patent notes that hydrogen reduced boron product was prone to boron hydride contamination, and he noted that alkali metal and alkaline earth metals are not used as reductants on a contention of contamination with borides.

It is known that boron trichloride reductions using hydrogen is endothermic at room temperatures, and can be carried out only at temperatures higher than 1600° C.—requiring exotic metal filaments and this process is expensive. Since the melting point of boron is 2076° C., the powdery deposit tend to stay amorphous.

Present invention, overcomes these obstacles, by careful thermochemical analysis of reduction processes of boron halides. The comparison is shown in Table 1 for boron trichloride [one of the halides] reduction with metals and hydrogen. It is discovered that reductions of boron halides by alkali metals, alkaline earth metals, aluminum and silicon are exothermic and have negative free energies of reaction at 298 K [room temperature 25° C]. Thus, these reactions can start at near room temperature provided the rate of reaction is favorable. Higher temperatures caused by the exothermic reaction will favor higher rates of conversion. But the boron tri-chloride reaction with hydrogen or iron has a positive free energy of reaction and does not happen at room temperature, and in addition the heat of reaction is positive, making the reaction endothermic. This is well known that hydrogen reduction of boron tri-chloride requires very high temperature and high energy input—thus this process is expensive.

The thermochemical analysis should also carryout the equilibrium reaction analysis to see what other contaminant side reactions take place. In the case of magnesiothermic reductions and aluminothermic reductions we can see that boride formations can occur as shown in Table 2. The boride formation staying as an impurity in the elemental boron is well known.

TABLE 1
Reduction Reactions of boron chlorides.

| | | Free energy |
|---|---|---|
| | Ht. of Reaction | of Reaction |
| Reaction | at 298 K, kcal | at 298 K, kcal |
| 2BCl₃ + 3H₂ = 2B + 6HCl | +252 | +204 |
| 2BCl₃ + 2Fe = 2B + 2FeCl₃ | +7 | +108 |
| 2BCl₃ + 3Zn = 2B + 3ZnCl2 | −443 | −333 |
| 2BCl₃ + 6Na = 2B + 6NaCl | −1661 | −1528 |
| 2BCl₃ + 6K = 2B + 6KCl | −1814 | −1677 |
| 2BCl₃ + 3Mg = 2B + 3MgCl₂ | −1119 | −1000 |
| 2BCl₃ + 15 Si = 2B + 1.5SiCl₄ | −238 | −163 |
| 2BCl₃ + 2Al = 2 B+ 2AlCl₃ | −605 | −484 |

TABLE 2
Boride Formation Reactions

| | | Free energy |
|---|---|---|
| | Ht. of Reaction | of Reaction |
| Reaction | at 298 K, kcal | at 298 K, kcal |
| 3g + 6B = 3MgB₂ | −276 | −268 |
| 3Mg + 12B = 3MgB₄ | −315 | −310 |
| Al+ 2B = AlB₂ | −67 | −65 |
| Al+ 12B = AlB₁₂ | −201 | −207 |
| Fe+ B = FeB | −71 | −70 |
| 3Si + 9B = 3SiB₃ | −133 | −121 |

The present invention notes that alkali metals do not form stable borides and is not shown in the Table 2. It is also known that most of transition metals form very stable borides, eg: iron boride, titanium boride, etc.

While the formation of magnesium borides and aluminum borides take place easily, the present invention notes that these borides can be easily converted to pure boron by reacting with boron tri-halide such as boron tri-chloride by exothermic reactions shown in Table 3.

TABLE 3
Boride reduction of boron trihalides

| | | Free energy |
|---|---|---|
| | Ht. of Reaction | of Reaction |
| Reaction | at 298 K, kcal | at 298 K, kcal |
| BCl₃ + FeB = 2B + FeCl₃ | +75 | +124 |
| 3SiB₃ + 4BCl₃ = 3SiCl₄ + 13B | −334 | −206 |
| 2BCl₃ + 3MgB₂ = 8B + 3MgCl₂ | −843 | −732 |
| AlB₁₂ + BCl₃ = AlCl₃ + 13B | −102 | −35 |
| AlB₂ + BCl₃ = AlCl₃ + 3B | −236 | −177 |

From Table 3, it can be inferred that iron borides are very stable and are not reduced by boron trichlorides as noted by positive free energy of reaction and endothermic heat of reaction. On the other hand, above table, generated as part of the present invention, notes that when using silicon, magnesium .or aluminum as the reducing agent for boron halides, the reactions tend to produce corresponding borides along with elemental boron in the initial step. Thus continued addition of boron tri-halides can convert the metallic the boride to metal halide and boron in the case of magnesium or aluminum or silicon. These reactions thus have to make sure that boron trihalide is in excess of the metallic reductant.

Use of alkali metal as a reducing agent may not need the step of excess boron trihalide addition. At the end, the continued addition of boron halides as little or no boride is formed even with the excess of alkali metal. The temperature of the reaction dictates the state of the metal halide product formed along with elemental boron. The kinetics of the reaction requires temperatures of above 150° C., and preferably in the 750 to 900° C. The reactants which produce metal halide vapors such as SiCl₄ require temperatures less than 500° C. to avoid boride residues maintain the cost of reaction low. The temperature control required for avoidance of aluminum boride residues in the boron halide reduction with aluminum is less than about 170° C. Use of reactants such as alkali metals or alkaline earth metals is preferably carried out at temperatures where the product metal chloride is present in the molten form. Following the reaction, the metal chlorides can be distilled off from the reactor at the high temperature, following which the reactor is cooled to remove elemental boron for further processing. It is also possible to shut the reactor, cool it and remove the combination of elemental boron and metal chloride and carry out acid washing—rinsing and drying to obtain pure elemental boron. Of these, the distillation approach is the preferred technique. The present invention thus makes semi-batch metallothermic reductions of boron halides in making pure boron of purity greater than 99% possible with careful programming of reactant additions.

As the metallothermic reductions shown here are exothermic, it lends itself to crystalline boron formation, provided the reactions take place in oxygen free reactor vessels having temperature controls by needed heat balancing. Temperature and pressure control is an important aspect of avoiding intermediate borides or reacting the intermediate boride with boron halides. The endothermic nature of most of the hydrogen reduction methods has not been helpful in the formation of crystalline boron.

Another aspect of the invention notes the following. The thermochemical reactions discussed earlier, also point out that the metal boride formation requires the presence of excess reductant—i.e. in the case of silicon or magnesium or aluminum, electrolytic processes wherein the boron halide is continually fed into the cathode chamber slightly in excess of the metal formation at the cathode. This would produce pure elemental boron in the amorphous or crystalline form while forming halogen gas at the anode which can be recycled to produce the boron halide needed, thus making the process more economical. Heretofore, use of boron trichlorides has not been utilized in any elemental boron production by electrolysis.

Finn's patent claimed only the reaction between zinc vapors and boron trihalides other than tri-fluoride. The present invention shows methods of more economic approaches of utilizing a liquid pool of zinc in an oxygen free reactor, or by reaction between continuously fed boron trihalide [other than trifluoride] to a cathode zone where metallic zinc is continuously formed.

I claim,:

1. A method to prepare pure elemental boron by chemical reduction of boron trihalides—wherein halides refer to fluoride or chloride or bromide or iodide—using any of the following—alkali metal, alkaline earth metal, aluminum, silicon, alkaline earth metal borides, aluminum borides or silicon borides as reducing agent.

2. The reaction in claim 1 where the boron halide is reacted with an alkali metal [such as sodium] in a reactor free of oxygen having temperature and pressure control means and the alkali metal halide formed is separated from the elemental boron. The temperature of reaction can be between 50 and 900° C., but preferably selected to keep the alkali metal halide in the molten form as a single or multiple alkali metal halide of lower melting point to maintain the alkali metal in a molten state to which the boron halide is added. At the end of the reaction, boron product is separated from the bulk molten alkali metal halide, and the adherent alkali metal halide is further separated from elemental boron by distillation or other methods.

3. The reaction in claim 1 where the boron halide is reacted with an alkaline earth metal [such as magnesium], in a reactor free of oxygen, having temperature and pressure control means to carryout the reaction until all the intermediate alkaline earth boride is reacted with boron trihalide. The temperature of reaction can be between 50 and 1000° C., but preferably selected to keep the alkaline earth metal halide in the molten form as a single or multiple alkali and alkaline earth metal halide of lower melting point to maintain the alkaline earth metal in a molten state to which the boron halide is added. The alkaline earth halide formed is then separated from the elemental boron—preferably by distillation prior to opening the reactor and to remove the elemental boron in a powdery form or a sponge form containing crystalline boron.

4. The reaction in claim 1 where the boron halide is reacted with silicon metal in a reactor free of oxygen, having temperature and pressure control means to carryout the reaction with means to continually remove the silicon tetrahalide until such a time the product gas contains no residual silicon boride denoting all the boride intermediate has reacted in the solid product; the pure elemental boron is then removed from the reactor. The temperature of the reaction is selected to assure no stable silicon borides are formed in spite of excess boron trihalide addition; and is preferably less than 500° C.

5. The reaction in claim 1 where the boron halide is reacted with aluminum metal in a reactor free of oxygen, having temperature and pressure control means to carryout the reaction with means to continually remove the aluminum trihalide until such a time the product gas contains no residual aluminum boride denoting all the boride intermediate has reacted in the solid product; the pure elemental boron is then removed from the reactor. The temperature of the reaction is selected to assure no stable aluminum borides are formed in spite of excess boron trihalide addition; and is preferably less than 170° C.

6. The reaction in claim 1, carried out by means of an electrowinning reactor where the formation of pure elemental boron is accomplished where the boron trihalide is fed continuously to the cathode zone where reducing agent—such as alkali metal, alkaline earth metal or aluminum or silicon freshly formed reacts with the boron halide making pure boron, while the halide ions are reduced as halogen at the anode. The halogen is recovered and recycled o produce boron halides for further reduction.

7. The reaction in claim 1, of the preparation of pure boron from borides of magnesium or aluminum or silicon, which may or may not contain elemental boron by means of reacting the borides in a reactor free of oxygen, having temperature and pressure control means to carryout the reaction with boron trihalides.

8. Reduction of boron halides[other than trifluoride] to elemental boron utilizing solid or a liquid pool of zinc in an oxygen free reactor with temperature and pressure controls; once the boron formation is finished the other product zinc halide is distilled off giving pure elemental boron.

9. The reaction in claim 8, on the elemental boron formation by reaction between continuously fed boron trihalide [other than trifluoride] to a cathode zone where metallic zinc is continuously formed to carry out the reduction to pure boron from the cathode zone and recyclable halogen formed at the anode. The zinc halide adhering to the removed cathode boron deposit is distilled off giving pure boron.
